(19) United States
(12) Patent Application Publication
(10) Pub. No.: US 2013/0344409 A1
(43) Pub. Date: Dec. 26, 2013

(54) MULTI-FUEL COMBUSTOR WITH SWIRL FLAME STABILIZATION

(71) Applicant: BERNHARD A. FISCHER, HONEOYE FALLS, NY (US)

(72) Inventor: BERNHARD A. FISCHER, HONEOYE FALLS, NY (US)

(73) Assignee: DELPHI TECHNOLOGIES, INC., TROY, MI (US)

(21) Appl. No.: 13/527,631

(22) Filed: Jun. 20, 2012

(51) Int. Cl. H01M 8/06; F23D 11/44; F23C 5/32; F23M 9/00

(52) U.S. Cl. 429/425; 431/182; 431/208; 431/215

(57) ABSTRACT

A combustor for generating and supplying hot combustion gases to a fuel reformer includes an annular passage defined by a swirler having a central hub and an outer wall. One or more vanes are disposed in the annular passage to impart angular momentum to a gas flowing axially through the annular passage. At least one opening is defined in the central hub for introducing a first fuel into the annular passage, and at least one opening is defined in the outer wall in for introducing a second fuel into the annular passage. In a further aspect of the invention, the fuel introduced into the annular passage through the outer wall is a gaseous fuel, for example effluent gas from a fuel cell, and the fuel introduced into the annular passage through the central hub is a vaporized liquid fuel, for example vaporized diesel fuel.

### STATEMENT REGARDING FEDERALLY SPONSORED RESEARCH OR DEVELOPMENT

This invention was made with Government support under DE-EE0000478 awarded by DOE. The Government has certain rights in this invention.

### TECHNICAL FIELD OF INVENTION

The present invention relates to a combustor with a combustion chamber for generating and supplying hot combustion gases to a hydrocarbon reactor in a fuel cell system; more particularly to a combustor configured to operate using a liquid fuel and/or a gaseous fuel, alone or in combination.

### BACKGROUND OF THE INVENTION

Fuel cells which generate electric current by controllably combining elemental hydrogen and oxygen are well known. One form of fuel cell, known as a solid oxide fuel cell (SOFC), includes a plurality of cells known as a fuel cell stack. Each cell includes an anode layer and a cathode layer separated by a permeable electrolyte formed of a ceramic solid oxide. In order to generate an electric current, the fuel cell stack requires a temperature above about 600° C. and preferably 800° C. or even higher. Hydrogen for use in the SOFC is typically derived by catalytically reforming hydrocarbons in a fuel reformer. In order for catalytic reforming of hydrocarbons, the fuel reformer requires a temperature above about 500° C. and preferably 850° C. Catalytic reforming of hydrocarbons is an endothermic process, and heat must be supplied to the fuel reformer to maintain the reformer at the required temperature for catalytic reforming to proceed.

In order to raise the temperature of the fuel reformer and fuel cell stack at start-up, it is known to provide a combustor for combusting hydrocarbons. The combustion of hydrocarbons produces hot combustion gases which are used to raise the temperature of the fuel reformer and fuel cell stack. A fuel vaporizer may be used to generate a vapor from a liquid hydrocarbon fuel to facilitate combustion of the hydrocarbons. It is known to provide a fuel vaporizer with an electric heating element which uses an electric current to vaporize the liquid hydrocarbon fuel passing through the fuel vaporizer. The vaporized hydrocarbon exiting the fuel vaporizer is then combusted in a combustion chamber of the combustor. The resulting hot combustion gases are then used to raise the temperature of the fuel reformer and fuel cell stack.

Once the reformer and fuel cell stack are operating, effluent gas from the anode of the fuel cell, also known as anode tail gas, is available. This gas contains excess hydrogen that was not reacted in the fuel cell. This hydrogen is available to act as a fuel for the combustor to supply heat to maintain the endothermic catalytic reaction in the reformer.

What is needed is a combustor that allows either liquid fuel or gaseous fuel, alone or in combination, to be combusted.

### BRIEF SUMMARY OF THE INVENTION

A combustor for generating and supplying hot combustion gases to a fuel reformer includes an annular passage defined by a swirler having a central hub and an outer wall. One or more vanes are disposed in the annular passage to impart angular momentum to a gas flowing axially through the annular passage. At least one opening is defined in the central hub for introducing a first fuel into the annular passage, and at least one opening is defined in the outer wall in for introducing a second fuel into the annular passage. In a further aspect of the invention, the fuel introduced into the annular passage through the outer wall is a gaseous fuel, for example effluent gas from a fuel cell, and the fuel introduced into the annular passage through the central hub is a vaporized liquid fuel, for example vaporized diesel fuel.

### BRIEF DESCRIPTION OF THE DRAWINGS

This invention will be further described with reference to the accompanying drawings, in which:

FIG. 1 is a schematic diagram of a fuel cell, fuel reformer, and combustor in accordance with the present invention; and

FIG. 2 is a cutaway view of a combustor in accordance with the present invention.

### DETAILED DESCRIPTION OF THE INVENTION

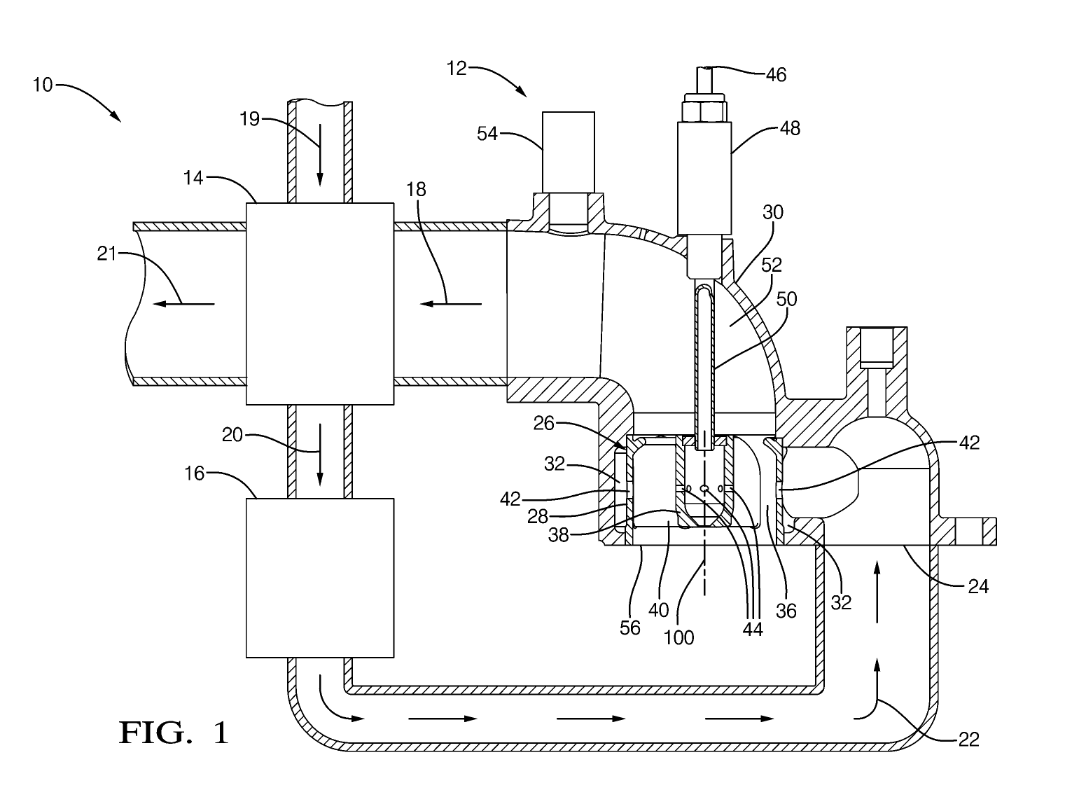

Referring to FIG. 1, a fuel cell system 10 is shown. Fuel cell system 10 includes a combustor 12, a fuel reformer 14, and a fuel cell 16. The combustor 12 is fluidly connected to the fuel reformer 14, and provides hot combustion gases 18 to raise the temperature of the fuel reformer 14. The reformer 14 receives a feedstream 19 that includes hydrocarbon fuel and air, and passes the feedstream 19 over a catalyst bed, converting the feedstream to a reformate gas 20 that contains hydrogen gas. The combustion gases 18 maintain the fuel reformer 14 at the proper operating temperature for the catalytic conversion of the feedstream 19 into the reformate 20, with no fluid communication between the heated combustion gases 18 from the combustor and the feedstream 19 or reformate gas stream 20. After passing through the reformer 14, the combustion gas 18 exits the reformer 14 as indicated by the arrow 21.

Continuing to refer to FIG. 1, the fuel reformer 14 is fluidly connected to the fuel cell 16, allowing the reformate 20 to be supplied to the fuel cell 16. The fuel cell 16 uses hydrogen gas contained in the reformate gas 20 to produce electricity. The fuel cell 16 is fluidly connected to the gaseous fuel inlet 24 of the combustor 12, allowing effluent gas 22 from the fuel cell that contains unreacted hydrogen gas to be supplied to the gaseous fuel inlet 24 of the combustor 12.

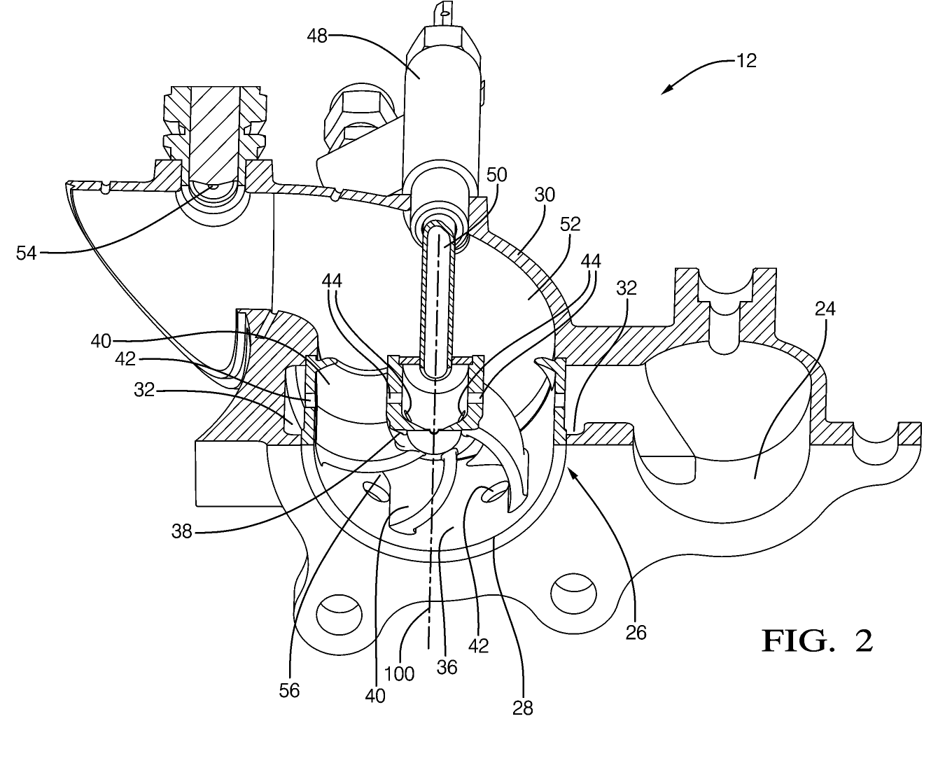

In the embodiment depicted in FIG. 1 and FIG. 2, the combustor 12 includes a housing 30 into which is inserted a swirler 26. The swirler 26 has an outer wall 28 disposed about the axis 100 that cooperates with the housing 30 to define an annular chamber 32 between the outer surface of the outer wall 28 and the inner surface of the housing 30, with the annular chamber 32 in fluid communication with the gaseous fuel inlet 24 of the combustor. The swirler also includes a hollow central hub 38 coaxial with the outer wall 28, with an annular passage 36 defined between the inner surface of the outer wall 28 and the central hub 38.

In the embodiment of FIG. 1 and FIG. 2, the swirler 26 includes a plurality of vanes 40 located in the annular passage 36. A plurality of holes 42 is defined in the outer wall 28 to fluidly connect the annular chamber 32 with the annular passage 36. A plurality of holes 44 is defined in the central hub 38 to fluidly connect the hollow center of the hub 38 with the annular passage 36.

The combustor in the embodiment of FIG. 1 and FIG. 2 further includes a means for vaporizing a liquid fuel, similar to that described in commonly owned patent application Ser. No. 12/964,806 titled “COMBUSTOR FOR A FUEL CELL SYSTEM” filed Dec. 10, 2010 and published as U.S. Patent Application Publication 2011/0269032, the contents of which are hereby incorporated by reference. Liquid fuel is introduced through the liquid fuel inlet 46 into an electrically heated vaporizer 48. Vaporized fuel from the vaporizer 48 is routed through the fuel tube 50, with the outlet of the fuel tube 50 fluidly connected to the hollow center of the hub 38. Vaporized fuel can be introduced into the annular passage 36 through the holes 44.

The housing 30 defines a combustion chamber 52 through which the fuel tube 50 passes. The combustor 12 also includes an igniter 54 used to assist combustion. The igniter 54 may for example be a spark source or may present a hot surface to the combustion chamber.

The combustor 12 defines an air inlet 56 in fluid communication with the annular passage 36. In operation, air introduced through the air inlet 56 moves axially through the annular passage 36 and mixes with fuel provided to the annular passage 36. The fuel may include gaseous fuel 22 introduced through the gaseous fuel inlet 24, the annular chamber 32, and the holes 42. The fuel may include vaporized liquid fuel introduced through the fuel tube 50 and the holes 44. The combustor may operate using only the gaseous fuel introduced through the holes 42, only the vaporized liquid fuel introduced through the holes 44, or both the gaseous fuel introduced through the holes 42 and the vaporized liquid fuel introduced through the holes 44 simultaneously.

The vanes 40 disposed in the annular passage 36 are arranged so as to impart angular momentum, also known as swirl, to the air/fuel mixture around the axis 100 as the air/fuel mixture flows axially through the swirler 26. This swirl aids in mixing the air and the fuel to promote stable combustion within the combustion chamber 52. The swirling motion also urges the air/fuel mixture into proximity to the igniter 54 to promote effective initiation of the combustion process. As the air/fuel mixture is burning within the combustion chamber 52, heat from the combustion process is transferred to the fuel tube 50. This heat aids the vaporization of the liquid fuel introduced into the liquid fuel inlet 46, thereby allowing the electric power to the electrically heated vaporizer 48 to be turned off once the temperature in the combustion chamber 52 has reached a sufficient level.

As discussed above, the gaseous fuel 22 is introduced through the gaseous fuel inlet 24, the annular chamber 32, and the holes 42. The gaseous fuel inlet 24 is located at one sided of the annular chamber 32, and the flow of the gaseous fuel 22 around the annular chamber 32 creates a pressure drop such that there is a pressure differential through the annular chamber 32. The diameter of each hole 42 is selected to compensate for this annular pressure loss effect and to equalize the mass flow rate of gaseous fuel 22 through each hole 42.

A combustor 12 as described herein can be used advantageously in a fuel cell system 10 during both steady-state operation and system start-up and shut-down. In steady-state operation of a fuel cell system 10, it is desirable to burn unreacted hydrogen that is present in the effluent stream (anode tail gas) 22 in a combustor 12 to provide heat to maintain the fuel reformer 14 at a temperature required for catalytic reforming of a feedstream 19. It may require a significant time period when a fuel cell system is started before the reformer 14 and the fuel cell 16 are at their steady-state temperatures such that adequate hydrogen is available in an effluent stream 22 to fuel the combustor 12. The combustor 12 as described herein can start using a liquid fuel, such as for example diesel fuel, to initiate the operation of a fuel cell system 10. As the fuel cell system 10 reaches operating temperature and hydrogen becomes increasingly available in the effluent stream 22, the amount of liquid fuel supplied to the combustor 12 can be reduced. Similarly, when shutting down a fuel cell system 10, it is desirable to ramp system temperatures down in a controlled fashion. Liquid fuel can advantageously be used during system shutdown to mitigate the low hydrogen conditions in the system 10. A combustor 12 as described herein allows stable combustion to be maintained even though the amount of hydrogen available for combustion varies greatly over the operating conditions of the system 10.

A temperature sensor may be provided to monitor the state of combustion in the combustor 12. The signal from the temperature sensor may be used by a controller to control actuators that affect, for example, the rate of air flow into the combustor, the rate of liquid fuel flow into the combustor, the actuation of the fuel vaporizer 48, the actuation of the igniter 54, and so on.

While this invention has been described in terms of embodiments thereof, it is not intended to be so limited, but rather only to the extent set forth in the claims that follow.

1. A combustor for generating and supplying hot combustion gases to a fuel reformer, said combustor comprising:
a housing defining a combustion chamber and having an exhaust port for discharging said hot combustion gases therefrom;
a swirler having a central hub and an outer wall, with an annular passage defined between the central hub and the outer wall;
one or more vanes disposed in said annular passage configured to impart angular momentum to a gas flowing axially through said annular passage;
at least one opening in the central hub for introducing a first fuel therethrough into the annular passage;
at least one opening in the outer wall in for introducing a second fuel therethrough into the annular passage.

2. The combustor of claim 1, wherein an annular chamber is defined between the housing and the outer wall of the swirler, the annular chamber being in fluid communication with a source of the second fuel.

3. The combustor of claim 2, wherein the at least one opening in the outer wall comprises a plurality of openings in the outer wall, and wherein the size of each opening of the plurality of openings is selected such that the flow of the second fuel from the annular chamber to the annular passage is essentially equal through each opening of the plurality of openings.

4. The combustor of claim 1, further comprising a fuel vaporizer having a fuel tube with an inlet for introducing liquid fuel therewithin, an outlet for dispensing vaporized fuel therefrom to said combustion chamber, and an electric heating element disposed between said inlet and said outlet, wherein a portion of said fuel tube extends into said combustion chamber and is exposed to said hot combustion gases exiting said combustion chamber;
wherein an electric current can be supplied to said electric heating element to vaporize said liquid fuel within said fuel tube when the temperature within said combustion chamber is below a predetermined temperature, and wherein substantially no electric current need be supplied to said electric heating element when the temperature within said combustion chamber is at least said predetermined temperature and said hot combustion gases passing over said portion of said fuel tube are sufficient to supply enough heat to vaporize said liquid fuel within said fuel tube,
wherein the outlet of the fuel tube is in fluid communication with the at least one opening in the central hub of the annular passage.

5. The combustor of claim 1 further comprising a first air inlet configured to axially introduce air into the annular passage.

6. A fuel cell system comprising:
a fuel reformer for generating reformate from a hydrocarbon fuel;
a fuel cell for generating an electric current, said fuel cell being fluidly coupled to said fuel reformer and receiving said reformate for use in generating said electric current; and
a combustor for generating and supplying hot combustion gases to said fuel reformer, said combustor comprising:
a housing defining a combustion chamber and having an exhaust port for discharging said hot combustion gases therefrom;
a swirler having a central hub and an outer wall, with an annular passage defined between the central hub and the outer wall;
one or more vanes disposed in said annular passage to impart angular momentum to a gas flowing axially through said annular passage;
an opening in the central hub for introducing a first fuel therethrough into the annular passage;
an opening in the outer wall in for introducing a second fuel therethrough into the annular passage.

7. A fuel cell system as in claim 6 wherein said combustor includes a first air inlet configured to axially introduce air into the annular passage.

8. A fuel cell system as in claim 6 wherein said combustor includes an inlet configured to introduce effluent gas from the fuel cell into said combustor.
